(19) United States
(12) Patent Application Publication
(10) Pub. No.: US 2020/0042959 A1
(43) Pub. Date: Feb. 6, 2020

(54) ENTERTAINMENT DOLLAR SYSTEM AND METHOD

(71) Applicants: Neruban Varatharajah, Markham ON (CA); Kapilan Uruthiralingam, Markham ON (CA)

(72) Inventors: Neruban Varatharajah, Markham ON (CA); Kapilan Uruthiralingam, Markham ON (CA)

(21) Appl. No.: 16/112,348

(22) Filed: Aug. 24, 2018

(30) Foreign Application Priority Data
Aug. 3, 2018 (CA) 3013312

(51) Int. Cl. G06Q 20/06; G06Q 20/18; G06Q 20/38

(52) U.S. Cl. CPC G06Q 20/06; G06Q 20/381; G06Q 20/18

(57) ABSTRACT

An entertainment dollar system and method of using establishment specific currency includes the steps of exchanging a country-currency for an establishment specific token-currency; providing the establishment specific token-currency in exchange for the country-currency; expending the establishment specific token-currency on club-related entertainment within a club; and a recipient exchanging the establishment specific token-currency for the country-currency. The establishment specific currency is used in participating gentlemen's clubs for paying dancers and for other use within the club.

### BACKGROUND OF THE INVENTION

This application claims benefit under 35 USC 119 to Canada National Application No. 3.013.312 filed Aug. 3, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of currency exchange and payments of existing art and more specifically relates to amusement currency.

### RELATED ART

When visiting clubs, people often give paper currency as tips for dancers. They may take out a bill and hand-deliver it to the dancer. This takes time and effort on the club customer and tips may be limited not by what the club customer wants to tip the dancer, but by the time and effort needed to get and deliver the currency. There have been instances of patrons using counterfeit money. Also, in some situations, the club customer may have a particular budget for tipping dancers in the club. However, without any way to track how much is being given out, the customer may find they have over spent beyond their tipping budget. A suitable solution is desired.

U.S. Pub. No. 2014/0165985 to Blair Robert Bryngelson relates to an apparatus for selectively ejecting or launching currency, coupons and advertising flyers, and other planar sheets. The described apparatus for selectively ejecting or launching currency, coupons and advertising flyers, and other planar sheets includes an apparatus for launching sheets such as paper money. The apparatus includes an upper housing and a lower housing detachably coupled to the upper housing. The apparatus includes a feed assembly, mounted to an interior space of the lower housing, and the feed assembly includes a plate with a planar upper surface for receiving the sheets and at least one spring element applying a spring force upon the plate to urge the planar upper surface toward the upper housing. The apparatus also includes an ejection assembly, supported within an interior space of the upper housing, adapted to sequentially eject the sheets from an opening in the upper housing or the lower housing. The ejection assembly includes an electric motor and a battery selectively powering the electric motor. Spaced apart wheels are provided on an axle driven by the motor to eject the sheets a distance of one to three feet.

### SUMMARY OF THE INVENTION

In view of the foregoing disadvantages inherent in the known currency exchange and payments art, the present disclosure provides a novel amusement currency. The general purpose of the present disclosure, which will be described subsequently in greater detail, is to provide an entertainment dollar system and method for promoting business within a club.

An entertainment dollar system and method of using establishment specific currency is disclosed herein. The method of using establishment specific currency includes exchanging a country-currency for an establishment specific token-currency; providing the establishment specific token-currency in exchange for the country-currency; expending the establishment specific token-currency on club-related entertainment within a club; and a recipient exchanging the establishment specific token-currency for the country-currency.

The establishment specific token-currency is provided preferably in increments of one dollar, but other denominations may be used. The establishment specific token-currency may be used as tips, specifically, to pay gentlemen's-entertainment-dancers. The establishment specific token-currency does not comprise the country currency thus promoting undisciplined spending. The establishment specific token-currency promotes patrons to spend the establishment specific token-currency within the club to promote club-loyalty. The establishment specific token-currency is useable in participating locations of the club. Further, the establishment specific token-currency comprises an anti-forgery integrated design, thus, dissuading use of counterfeit country-currency.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an entertainment dollar system and method of using establishment specific currency, constructed and operative according to the teachings of the present disclosure.

FIG. 1 is a flow diagram illustrating an entertainment dollar system and method of using establishment specific currency, according to an embodiment of the present disclosure.

FIG. 2 is a perspective view of the entertainment dollar system during an ‘in-use’ condition, according to an embodiment of the present disclosure.

FIG. 3 is a perspective view of the entertainment dollar system, according to an embodiment of the present disclosure.

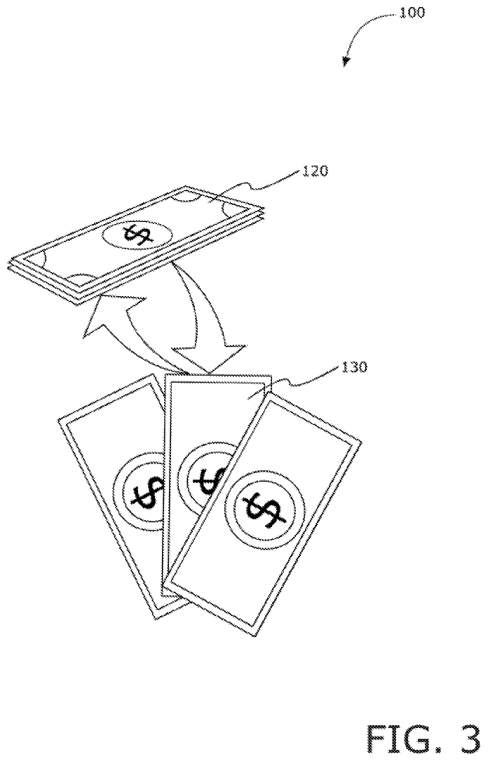

The various embodiments of the present invention will hereinafter be described in conjunction with the appended drawings, wherein like designations denote like elements.

### DETAILED DESCRIPTION

As discussed above, embodiments of the present disclosure relate to a currency exchange and payments and more particularly to an amusement currency as used to improve the use of currency in a gentlemen's club.

Generally, the entertainment dollar system and method of using establishment specific currency is a system of printing currency for the gentlemen's entertainment industry. The patrons purchase club ‘dollars’ to pay dancers with, and then the dancers may then cash in their tips at the end of the evening. The club dollars may also be used for other transactions within a participating club. The club dollars will be printed with anti-forgery elements and be unique to each gentleman's entertainment business. The invention makes it more difficult to use forged currency in the gentleman's entertainment business. Paper currency may be provided in $1.00 increments. In a preferred embodiment, the currency will be sold to each establishment with a unique design that can only be used at their locations or other participating locations. The money can be renewed on a continuous basis with changes to the pattern and design, as to provide an extra layer of security from potential forgeries and to keep the bills fresh, clean and undamaged.

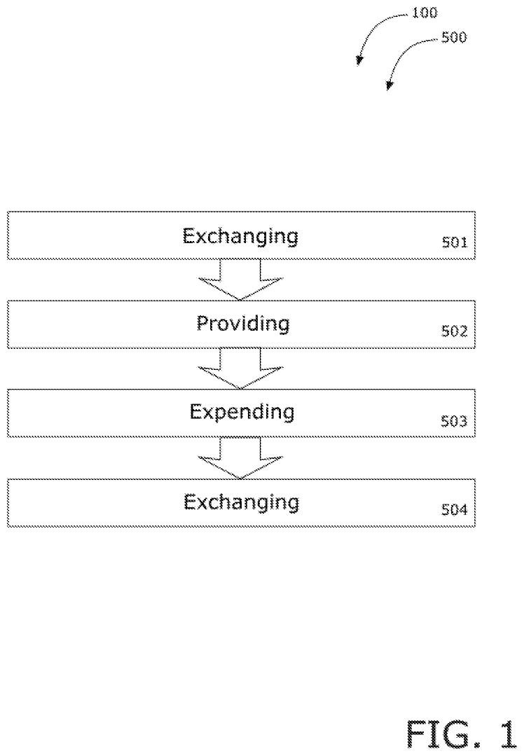

Referring now more specifically to the drawings by numerals of reference, there is shown in FIG. 1 a flow diagram illustrating a method of using establishment specific currency 500, according to an embodiment of the present disclosure. In particular, the method of using establishment specific currency 500 may include one or more components or features of the method of using establishment specific currency 100 as described above. As illustrated, the method of use 500 may include the steps of: step one 501, exchanging a country-currency 120 for an establishment specific token-currency 130; step two 502, providing the establishment specific token-currency 130 in exchange for the country-currency 120; step three 503, expending the establishment specific token-currency 130 on club-related entertainment within a club; and step four 504, a recipient exchanging the establishment specific token-currency 130 for the country-currency 120. The present invention provides a currency exchange system and means for payment of cash to exotic dancers in a club or on stage.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for method of using establishment specific-currency 500, are taught herein.

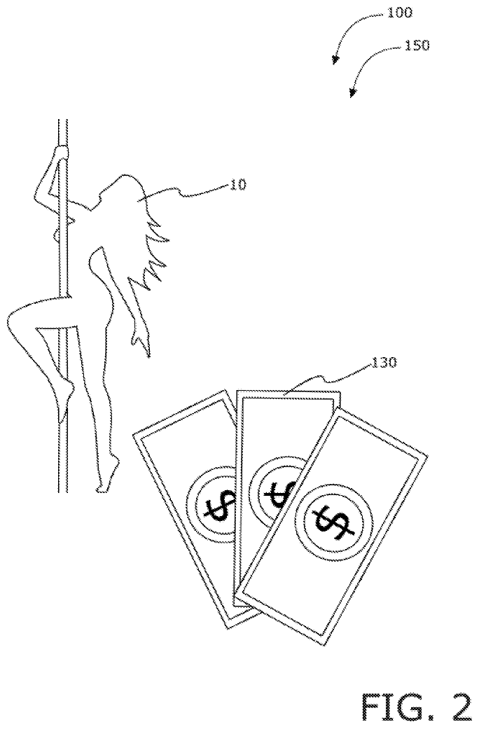

Referring now to FIG. 2 showing a perspective view of the entertainment dollar system 100 during an ‘in-use’ condition 150. Customers are able to convert USD (or other) currency (including cryptocurrencies, vouchers or coupons where the establishment accepts them) into establishment specific token-currency 130 for use within a club or other establishment. In a preferred embodiment, the establishment specific token-currency 130 is provided in increments of one dollar. The establishment specific token-currency 130 is used as tips, specifically, to pay gentlemen's-entertainment-dancers 10. The establishment specific token-currency 130 is useable and transferable to other club-related entertainment within the establishment. The establishment specific token-currency is vendable at a club via vending machines or manual vending. The establishment specific token-currency 130 may be ejected from a kiosk, machine, or be received from a worker at the club.

Use of the establishment specific token-currency 130 dissuades use of counterfeit country-currency 120 in clubs. The establishment specific token-currency 130 comprises an anti-forgery integrated design. The establishment specific token-currency 130 comprises printed and integral security measures. The establishment specific token-currency 130 may be printed on paper, plastic, or coins. In order to prevent potential forgeries, a design or pattern of the establishment specific token-currency 130 may be renewed on a continuous basis.

The establishment specific token-currency 130 does not comprise the country-currency 120 thus promoting undisciplined spending or if used differently via tracking may promote disciplined spending. The establishment specific token-currency 130 promotes patrons to spend the establishment specific token-currency 130 within the club to promote club-loyalty. The establishment specific token-currency 130 is useable in participating locations of the club. The establishment specific token-currency 130 has no value external from the establishment unless at participating locations of the club. In a preferred embodiment, the club includes a gentlemen's club. Further, the establishment specific token-currency 130 creates a unique experience and may be used for giveaways, parties, and events.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of using establishment specific currency comprising:
exchanging a country-currency for an establishment specific token-currency;
providing said establishment specific token-currency in exchange for said country-currency;
expending said establishment specific token-currency on club-related entertainment within a club; and
a recipient exchanging said establishment specific token-currency for said country-currency.

2. The method of using establishment specific currency of claim 1, wherein the establishment specific token-currency is provided in increments of one dollar.

3. The method of using establishment specific currency of claim 1, wherein the establishment specific token-currency is transferable to other club-related entertainment within the establishment.

4. The method of using establishment specific currency of claim 1, wherein use of said establishment specific token-currency dissuades use of counterfeit said country-currency.

5. The method of using establishment specific currency of claim 1, wherein the establishment specific token-currency is used as tips.

6. The method of using establishment specific currency of claim 5, wherein the tips are used to pay dancers.

7. The method of using establishment specific currency of claim 6, wherein the dancers are gentlemen's-entertainment-dancers.

8. The method of using establishment specific currency of claim 1, wherein the establishment specific token-currency comprises an anti-forgery integrated design.

9. The method of using establishment specific currency of claim 1, wherein the establishment specific token-currency comprises printed and integral security measures.

10. The method of using establishment specific currency of claim 1, wherein the establishment specific token-currency is printed on paper.

11. The method of using establishment specific currency of claim 1, wherein the establishment specific token-currency is printed on plastic.

12. The method of using establishment specific currency of claim 1, wherein the establishment specific token-currency is vendable.

13. The method of using establishment specific currency of claim 12, wherein the establishment specific token-currency is ejected from a kiosk.

14. The method of using establishment specific currency of claim 12, wherein the establishment specific token-currency comprises coins.

15. The method of using establishment specific currency of claim 1, wherein the establishment specific token-currency does not comprise the country currency thus promoting undisciplined spending.

16. The method of using establishment specific currency of claim 1, wherein the establishment specific token-currency promotes patrons to spend said establishment specific token-currency within said club to promote club-loyalty.

17. The method of using establishment specific currency of claim 1, wherein the establishment specific token-currency is useable in participating locations of said club.

18. The method of using establishment specific currency of claim 17, wherein the establishment specific token-currency has no value external from said establishment unless at participating locations of said club.

19. The method of using establishment specific currency of claim 1, wherein the club is a gentlemen's club.

20. A method of using establishment specific currency, the method comprising:
exchanging a country-currency for an establishment specific token-currency;
providing said establishment specific token-currency in exchange for said country-currency;
expending said establishment specific token-currency on club-related entertainment within a club;
a recipient exchanging said establishment specific token-currency for said country-currency;
wherein the establishment specific token-currency is provided in increments of one dollar;
wherein the establishment specific token-currency is transferable to other club-related entertainment within the establishment;
wherein use of said establishment specific token-currency dissuades use of counterfeit said country-currency;
wherein the establishment specific token-currency is used as tips;
wherein the tips are used to pay dancers;
wherein the dancers are gentlemen's-entertainment-dancers;
wherein the establishment specific token-currency comprises an anti-forgery integrated design;
wherein the establishment specific token-currency comprises printed and integral security measures;
wherein the establishment specific token-currency is printed on paper;
wherein the establishment specific token-currency is vendable;
wherein the establishment specific token-currency does not comprise the country currency thus promoting undisciplined spending;
wherein the establishment specific token-currency promotes patrons to spend said establishment specific token-currency within said club to promote club-loyalty;
wherein the establishment specific token-currency is useable in participating locations of said club;
wherein the establishment specific token-currency has no value external from said establishment unless at participating locations of said club; and
wherein the club is a gentlemen's club.
